(19) United States
(12) Patent Application Publication
(10) Pub. No.: US 2025/0003744 A1
(43) Pub. Date: Jan. 2, 2025

(54) Monitoring Concentricity

(71) Applicant: Jenny Science AG, Rain (CH)

(72) Inventor: Michael Lang, Rain (CH)

(21) Appl. No.: 18/759,406

(22) Filed: Jun. 28, 2024

(30) Foreign Application Priority Data
Jun. 29, 2023 (DE) 10 2023 117 273.5

(51) Int. Cl. G01B 21/22

(52) U.S. Cl. CPC G01B 21/22

(57) ABSTRACT

A motor has a position sensor having an encoder ring and two measurement sensors. The measurement sensors have a rotational angle distance from one another as seen about the axis of rotation and are arranged to each output one piece of position information in relation to a rotary orientation of the encoder ring dependent on an angular position of the rotor relative to the stator. A method for monitoring a concentricity of a rotor rotating in a stator about an axis of rotation in the motor includes: in a working angle position of the rotor relative to the stator, by using each measurement sensor, detecting one piece of working position information in a working condition of the motor; determining a working condition metric characterizing a distance between the two measurement sensors based on the working position information; and outputting a concentricity error if the working condition metric fulfills a condition.

### TECHNICAL FIELD

The present invention relates to a method for monitoring a concentricity of a motor, a control device for carrying out the method and a detector with the control device.

### BACKGROUND

From the publications US 2023/022341 A1 and US 2023/142572 A1 a detector for determining a position for a motor with a rotor rotatable in a stator about an axis of rotation is known, comprising an encoder ring and two measurement sensors, wherein the measurement sensors have a rotational angle distance from each other as seen about the axis of rotation and are arranged to each output one piece of position information in relation to a rotary orientation of the encoder ring dependent on an angular position of the rotor relative to the stator.

### SUMMARY

It is the object of the invention to improve the use of the known position sensor.

The task is fulfilled by the characteristics of the independent claims. Preferred embodiments are the subject matter of the dependent claims.

According to one aspect of the invention, a method for monitoring a concentricity of a rotor rotating in a stator about an axis of rotation in a motor with a detector having an encoder ring and two measurement sensors, wherein the measurement sensors have a rotational angle distance from one another as seen about the axis of rotation and are arranged to each output one piece of position information in relation to a rotary orientation of the encoder ring dependent on an angular position of the rotor relative to the stator:
a working position detection step in which, in a working angle position of the rotor relative to the stator, each measurement sensor detects one piece of working position information in a working condition of the motor;
a working condition metric determination step in which a working condition metric characterizing a distance between the two measurement sensors is determined based on the detected working position information; and
a monitoring step in which a concentricity error is output if the working condition metric fulfils a predetermined condition.

The specified method is based on the fact that in motors, the wear of bearing elements such as ball bearings and linear bearings is the critical factor for their service life. The raceways or rolling elements are subject to normal wear. If there is no regular maintenance with relubrication, this wear is even greater. If the failure of a bearing element is not detected in time, the motor is suddenly no longer functional and this can lead to the total failure of a system with correspondingly expensive production interruptions. Under certain circumstances, the sudden standstill of the motor can also lead to mechanical collisions in the system, which can damage other components. The early detection of an imminent motor failure is therefore very important in plant engineering.

One way of detecting an imminent failure is to monitor the concentricity of the motor, which allows the condition of the bearing elements to be monitored and a possible failure to be predicted. By continuously monitoring and analyzing measurement data, such as vibrations or temperatures, an imminent failure of a bearing or other component can be detected. This means that replacement can be planned and carried out in good time before a failure occurs. Predicting wear and failure by monitoring the concentricity is an effective method of increasing the reliability of electrical machines and preventing production downtime.

Until now, concentricity has been monitored by means of vibration, temperature or acoustics.

In contrast, the specified method is based on the consideration that rotary axes with positioning capability typically have an incremental or absolute measuring system installed. A measurement sensor scans the encoder ring in the form of a round measuring disk to detect the angular position of the motor. If the encoder ring has more than one measurement sensor, it is possible to detect a shift in the rotor pivot point relative to the stator. In this way, the smallest displacements of the shaft to the center can be detected.

The encoder ring and the measurement sensors can be based on any measuring principle, such as optical or magnetic. In principle, it does not matter whether the encoder ring is mounted on the rotor and the measurement sensors on the stator or vice versa. For reasons of practicality, however, the encoder ring is mounted on the rotor.

In the context of the specified method, the term metric is a value for describing the relative distance or ratio between the two measurement sensors. It can describe the distance directly but also indirectly with information from which the distance can then be derived.

In a further embodiment of the specified method, the working position detection step and the working condition metric determination step are carried out in different working angle positions of the rotor relative to the stator in the working condition of the motor and a working condition metric series is established over the different working angle positions, wherein the predetermined condition comprises a maximum change in the working condition metrics within the working condition metric series.

The embodiment is based on the consideration that the distance and thus the working condition metric between the two measurement sensors remains constant in the case of ideal concentricity. By considering the working condition metric over different working angle positions, a change in the working condition metric over different working angle positions can be used to directly infer insufficient concentricity.

In an additional embodiment, the specified method further comprises:
a reference position detection step in which, in a reference angular position of the rotor relative to the stator, reference position information is acquired with each measurement sensor in a reference condition of the motor; and
a reference condition metric determination step in which a reference condition metric characterizing a distance between the two measurement sensors is determined based on the acquired reference position information; and
determining the predetermined condition based on the reference condition metric.

The embodiment is based on the consideration that concentricity inaccuracies can result not only from signs of wear but also from other factors that are, for example, production-related and therefore do not affect the service life of the motor. These concentricity inaccuracies, which are therefore not important for monitoring the motor, can be taken into account with the reference condition metric and calculated out of the predetermined condition in such a way that they are no longer taken into account during monitoring.

In a particular further embodiment of the specified method, the reference position detection step and the reference condition metric determination step are carried out in various reference angle positions of the rotor relative to the stator in the reference condition of the motor and a reference condition metric series is established over the various reference angle positions, with the predetermined condition being created based on the reference condition metric series. In this way, the concentricity can be defined in a condition determined as faultless, such as after delivery from the factory, and taken into account when monitoring the concentricity accuracy.

In this process, the reference metric and/or the reference condition metric series can be stored.

To record the reference condition metric series, the reference metric and/or the reference condition metric series can be recorded in a learning run in which the rotor of the motor is rotated around the stator before the working condition. This learning run can then define the reference condition and distinguish it from the working condition.

In another embodiment of the specified method, the two measurement sensors are arranged at a distance of between 45° and 135°, preferably 75° and 105°, particularly preferably 90°. In an optimum arrangement, with the best possible detection of an axial displacement, the measurement sensors are spaced 90° apart. The further this arrangement deviates from 90°, the lower the effects of concentricity inaccuracies in the working condition metric, which ultimately affects the accuracy.

Particularly preferably, the working condition metric describes an angular offset of the two measurement sensors about the axis of rotation in the working condition.

According to a further aspect of the invention, a control device is arranged to implement one of the specified methods.

In a further embodiment, the specified device has a memory and a processor. The specified method is saved in the memory in the form of a computer program, and the processor is provided for executing the method when the computer program is loaded from the memory into the processor.

According to another aspect of the invention, a computer program comprises program code tools for executing all the steps of the specified method when the computer program is executed on an electronic device or one of the specified devices.

According to another aspect of the invention, a computer program product contains a program code which is saved on a computer-readable data carrier, and which carries out the specified method when it is executed on a data processing device.

According to a further aspect of the invention, a detector for a motor with a rotor rotatable in a stator about an axis of rotation comprises an encoder ring, two measurement sensors, wherein the measurement sensors have a rotational angle distance from one another as seen about the axis of rotation and are arranged to each output one piece of position information in relation to a rotary orientation of the encoder ring dependent on an angular position of the rotor relative to the stator, and one of the specified control devices for carrying out one of the aforementioned methods.

### BRIEF DESCRIPTION OF FIGURES

The above-described properties, features and advantages of this invention, as well as the manner in which they are achieved, will become clearer in connection with the following description of the embodiments, which are explained in more detail in connection with the drawing, in which:

FIG. 1 shows an exploded view of a motor with a detector,

FIG. 2 shows a sectional view of the motor with the detector of FIG. 1,

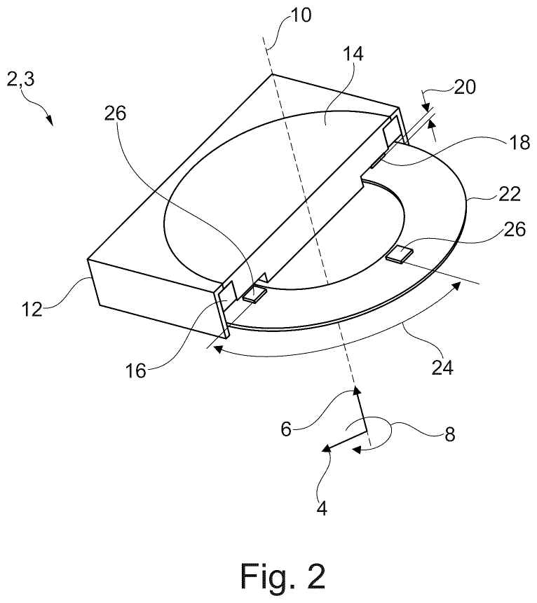

FIG. 3 shows a structural diagram of a method for monitoring a concentricity in a motor with the detector of FIGS. 1 and 2,

FIG. 4 shows a sketch of the detector of FIGS. 1 and 2 with which measurement are made without concentricity inaccuracies, and

FIG. 5 shows a sketch of the detector of FIGS. 1 and 2 with which measurements are made with concentricity inaccuracies.

In the figures, the same technical elements are provided with the same reference signs, and are only described once. The figures are purely schematic and, in particular, do not reflect the actual geometric proportions.
2 Motor
3 Detector
10 Axis of rotation
12 Stator
14 Rotor
16 Anti-friction bearing
18 Encoder ring
20 Axial distance
22 Printed circuit board
24 Rotational angle distance
26 Measurement sensor
27 Rotary orientation
28 Working position information
30 Reference sign
32 Filter
34 Sensor angle position
36 Working condition metric determination
38 Recorder
40 Angular position
42 Working condition metric series
44 Monitoring device
46 Predetermined condition
48 Warning signal
50 Buffer element
52 Reference position information
54 Reference condition metric
56 Reference condition metric determination
58 Reference condition metric series
60 Evaluation device
58′ Delayed reference condition metric series

### DETAILED DESCRIPTION

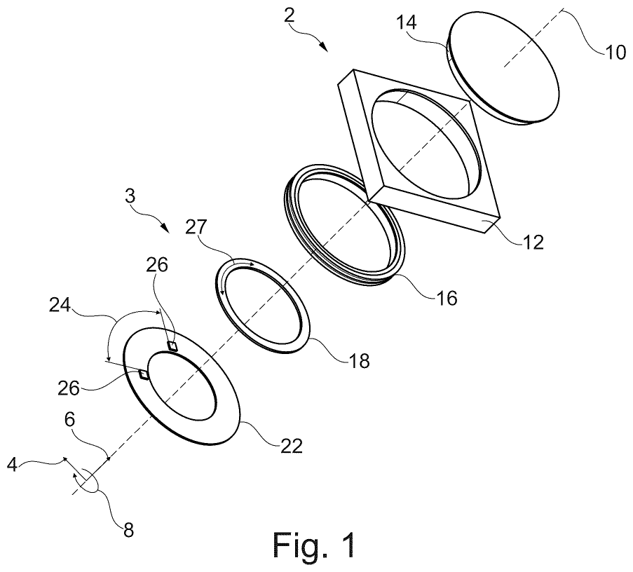

Reference is made to FIG. 1, which shows a motor 2 with a detector 3 in a space which is spanned by a radial direction 4, an axial direction 6 at right angles to the radial direction 4 and a tangential direction 8 running at right angles to the radial direction 4 and around the axial direction 6.

The motor 2 is arranged with the detector 3 around an axis of rotation 10 aligned in the axial direction 6 and has a stator 12 in which a rotor 14 is rotatably arranged. The stator 12 serves as the motor housing, in which the detector 3 is also accommodated. The rotor 14 is designed as a rotary flange and is driven in a manner known per se by drive means not shown further, such as an electric field, rotating about the axis of rotation 10.

In principle, the rotor 14 can be sliding mounted in the stator 12. To reduce friction, the rotor 14 in the present embodiment is mounted in the stator 12 via an anti-friction bearing 16, for example in the form of a ball or roller bearing.

An encoder ring 18, which is part of the detector 3, is held on the rotor 14 and is rotationally symmetrical to the rotational axis. The encoder ring 18 is designed to excite a variable encoder field in the tangential direction 8, which can be magnetic, optical, electrical or similar, depending on the operating principle of the position sensor. Such structures are well known and need not be explained further for the sake of brevity.

A printed circuit board 22 is held on the stator 12 at an axial distance 20 from the encoder ring 18, on which two measurement sensors 26 are arranged at an angular distance 24. Each measurement sensor 26 is arranged to detect a variable encoder field of the encoder ring 18 and thus a rotary orientation 27 of the encoder ring and to convert it into position information which contains the position or the orientation of the encoder ring 18 and thus of the rotor 14 relative to the stator 12.

The measurement sensors in such motors work separately from each other and generate two independent pieces of position information. These can then be processed by a motor control unit and a safety control unit. One of the main features of such a motor is its position redundancy. If one of the measurement sensors fails, the motor can be kept running and a system failure is averted. In this case, the control unit can issue a warning. If the motor is functioning properly, the control and regulation results resulting from the position information of the first measurement sensor should be approximately identical to those of the second measurement sensor. Differences can be taken as an indication that something is wrong and the safety control unit can stop the motor.

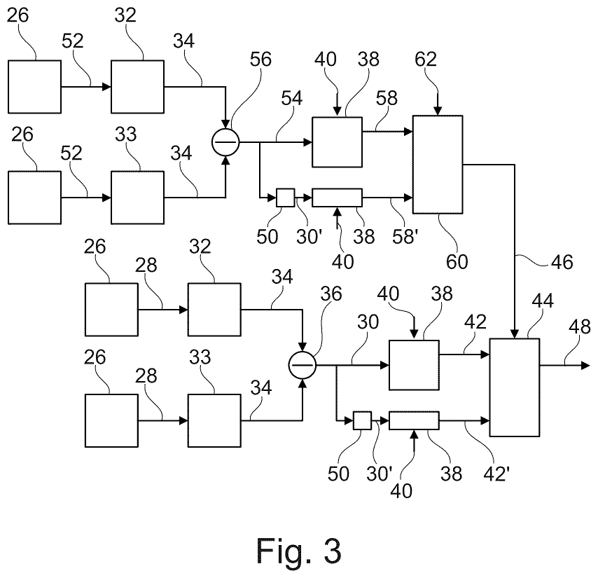

FIG. 3 below describes a method that extends the idea of using two redundant measurement sensors to find faults by monitoring the concentricity of the motor.

First of all, motor 2 is considered in a working condition. This is a condition in which the motor 2 fulfills its intended purpose when it is installed in a robot application, a machine tool or otherwise in automation technology. The position information of each measurement sensor 26 output in this condition is hereinafter referred to as working position information and is marked with the reference sign 28 in FIG. 3.

A metric is determined from the working position information 28, which characterizes a distance between the two measurement sensors 26 in the tangential direction 8. This metric is hereinafter referred to as the working condition metric and is provided with the reference sign 30 in FIG. 3. To determine the working condition metric 30, a filter 32 is first used to determine from the working position information 28 of each measurement sensor 26 the sensor angle position 34 of the respective measurement sensor 26 with respect to a specific zero position on the stator 12. This zero position can be selected at will and is not relevant for further understanding of the method.

In the present embodiment, the sensor angle positions 34 are then simply subtracted from each other in a subtraction element and thus directly result in the distance between the two measurement sensors 26 in the tangential direction 8 and thus an example of the working condition metric 30 to be determined. Therefore, the subtraction element determining this metric is referred to below as the working condition metric determination and is provided with the reference sign 36 in FIG. 3.

The working condition metric 34 is finally plotted in a recorder 38 over the angular position 40 of the rotor 14 relative to the stator 12 to form a working condition metric series 42. The individual values of the working condition metric series 42 can then be compared with at least one predetermined condition 46 in a monitoring device 44 to monitor the concentricity. Depending on the design of the algorithm, the monitoring device 44 can then output a warning signal 48 if the predetermined condition 46 is fulfilled or is no longer fulfilled and the concentricity of the motor 2 is therefore no longer ensured.

For this purpose, the predetermined condition 46 can in the simplest case be designed as a fixed value, which firmly specifies the working condition metric 34 and thus in the present example the distance between the two measurement sensors 26 and the correct concentricity. As soon as the working condition metric 30 leaves this predetermined distance within certain tolerances, a decision can be made on concentricity inaccuracy and the warning signal 48 can be output.

However, this type of monitoring is comparatively inaccurate, as the entire distance between the two measurement sensors 26 is always considered as the information to be monitored. It would be better to focus on the information of interest, in this case the change in the distance between the two measurement sensors 26. For this purpose, a currently determined working condition metric 30 can be delayed with a buffer element 50 and the delayed working condition metric 30′ can be plotted again in a further recorder 38 via the angular position 40 of the rotor 14 relative to the stator 12 to form a delayed working condition metric series 42′. In this way, the monitoring device 44 can monitor the change in the working condition metric 30, whereby the predetermined condition would then have to be adapted accordingly as a maximum change in the change in the working condition metric 30.

To further improve the method, the concentricity can also be considered in a reference condition of the motor 2 and taken into account when specifying the predetermined condition 46. Such a reference condition can be assumed, for example, during commissioning of a higher-level system using the motor 2.

In principle, the position information is recorded again in such a reference condition, but here as reference position information 52, from which the sensor angle positions 34 are then determined again in corresponding filters 32 to determine a reference condition metric 54 analogous to the working condition metric 30 in a reference condition metric determination 56 in the form of a subtractor. The reference condition metric 54 is then again plotted in a recorder 38 analogous to the working condition metric 30 to form a reference condition metric series 58, whereby here too a delayed reference condition metric series 58′ can optionally be formed via a buffer element 50.

Unlike in the case of monitoring the working condition metric 30, however, an evaluation device 60 now determines the predetermined condition 46 from the reference condition metric series 58 and optionally from the delayed reference condition metric series 58′ as the basis for monitoring 44. In this way, intrinsic concentricity inaccuracies that are already present during the aforementioned commissioning can be taken into account and suppressed from the predetermined condition.

To set the accuracy of the monitoring, a type of reference variable 62 of the evaluation device 60 can be specified for the predetermined condition.

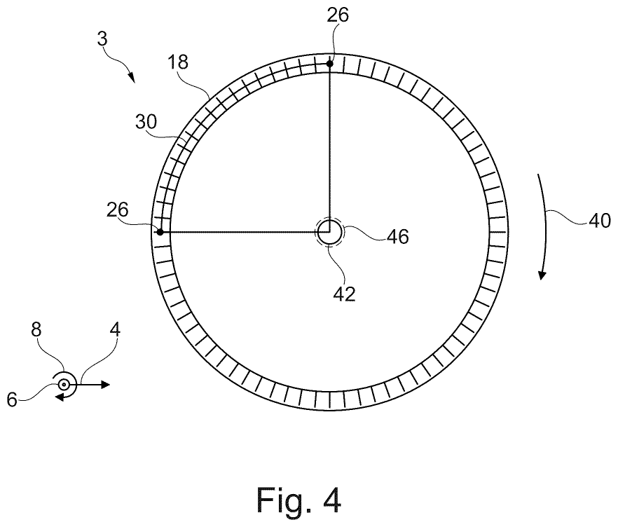

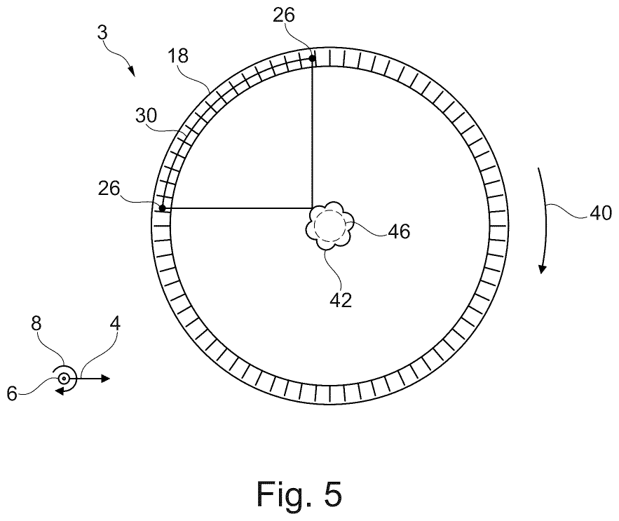

To explain the effect of the method with the detector 3 in the case of operation of motor 2 with and without concentricity inaccuracy is explained below using FIGS. 4 and 5.

The case of operation of motor 2 without concentricity inaccuracy is shown in FIG. 4. The course of the working condition metric 30 over the angular position 40 and thus the working condition metric series 42 is shown in FIG. 4 with a solid line. For better classification, the predetermined condition 46 is plotted over the angular position 40 with a dotted line.

It can be clearly seen in FIG. 4 that the working condition metric series 42 always remains within the limits specified by the predetermined condition 46 and thus fault-free operation without concentricity inaccuracy can be clearly distinguished from fault-free operation, which is shown in comparison in FIG. 5.

1. A method for monitoring a concentricity of a rotor rotating in a stator about an axis of rotation in a motor with a position sensor having an encoder ring and two measurement sensors, wherein the measurement sensors have a rotational angle distance from one another as seen about the axis of rotation and are arranged to each output one piece of position information in relation to a rotary orientation of the encoder ring dependent on an angular position of the rotor relative to the stator, comprising:
a working position detection step in which, in a working angle position of the rotor relative to the stator, each measurement sensor detects one piece of working position information in a working condition of the motor;
a working condition metric determination step in which a working condition metric characterizing a distance between the two measurement sensors is determined based on the acquired working position information; and
a monitoring step in which a concentricity error is output if the working condition metric fulfills a predetermined condition.

2. The method according to claim 1, wherein the working position detection step and the working condition metric determination step are carried out in different working angle positions of the rotor relative to the stator in the working condition of the motor and a working condition metric series is established over the different working angle positions, wherein the predetermined condition comprises a maximum change in the working condition metrics within the working condition metric series.

3. The method according to claim 1, comprising:
a reference position detection step in which, in a reference angle position of the rotor relative to the stator, each measurement sensor detects one piece of reference position information in a reference condition of the motor;
a reference condition metric determination step in which a reference condition metric characterizing a distance between the two measurement sensors is determined based on the acquired reference position information; and
determining the predetermined condition based on the reference condition metric.

4. The method according to claim 3, wherein the reference position detection step and the reference condition metric determination step are carried out in different reference angle positions of the rotor relative to the stator in the reference condition of the motor and a reference condition metric series is established over the different reference angle positions, wherein the predetermined condition is determined on the basis of the reference condition metric series.

5. The method according to claim 4, wherein the reference condition metric and/or the reference condition metric series are stored.

6. The method according to claim 3, wherein the reference condition is part of a learning run in which the rotor of the motor is rotated in the stator prior to the working condition.

7. The method according to claim 1, wherein the two measurement sensors are arranged at a distance of between 45° and 135°, preferably 75° and 105°, particularly preferably 90°.

8. The method according to claim 1, wherein the working condition metric describes an angular offset of the two measurement sensors about the axis of rotation in the working condition.

9. A control device configured to execute a method of claim 1.

10. A detector for a motor with a rotor rotatable in a stator about an axis of rotation, comprising:
an encoder ring;
two measurement sensors, wherein the measurement sensors have a rotational angle distance from one another as seen about the axis of rotation and are arranged to each output one piece of position information in relation to a rotary orientation of the encoder ring which is dependent on an angular position of the rotor relative to the stator; and
a control device of claim 9.
